(19) United States
(12) Patent Application Publication
(10) Pub. No.: US 2003/0061074 A1
(43) Pub. Date: Mar. 27, 2003

(54) Patient information management system

(75) Inventors: Rabindranath Dutta, Austin, TX (US); Karthikeyan Ramamoorthy, Austin, TX (US)

Correspondence Address: Cynthia S. Byrd, International Business Machines, Intellectual Property Law, 11400 Burnet Rd., Austin, TX, 78758, US

(73) Assignee: International Business Machines Corporation, Armonk, NY (US)

(21) Appl. No.: 09/965,003

(22) Filed: Sep. 27, 2001

(51) Int. Cl. G06F 17/60

(52) U.S. Cl. 705/4

(57) ABSTRACT

A computer product, method, and system for managing patient prescription information is provided. A patient prescription for a specified medication is received, typically at a pharmacy, where the availability of insurance coverage from an insurance company for the patient prescription is verified. In addition, an insurance payment category for the prescription is verified. Payment is collected from the patient based on the payment category. The payment category and the payment is transmitted to the insurance company exclusive of the medication information.

### FIELD OF THE INVENTION

The present invention relates to a system and method for storing and managing patient information. More particularly, the present invention relates to a system and method for storing and disseminating patient prescription information in a secure manner.

### BACKGROUND OF THE INVENTION

Insurance carriers, heath care providers and pharmacies routinely use computers to store and exchange patient medical information. Inherent in the advantages of using computer to store and exchange medical information are risks of violating a patient's privacy. Information is easily transferred among entities often without the knowledge or consent of the patient. One area of concern is patient prescriptions.

Pharmacies are used to dispense medications in accordance with prescriptions provided by a patient's doctor. The pharmacy has the task of getting the right medication to the patient and in most cases collecting the balance due from the patient's insurance carrier. Pharmacies perform other essential functions such as checking a patient's prescription history and warning a patient when an adverse drug reaction may occur between different medications. Since the patient is free to choose which pharmacy they use, patients may use several pharmacies for different prescriptions. Each individual pharmacy therefore has no way of warning the patient of potential interactions with medications that are not in their pharmacy database. Therefore it would be useful to have a means for recording and storing all the medications a patient is taking in a form that is controlled by the patient where the risk of compromising patient confidential information is minimized.

### SUMMARY OF THE INVENTION

The present invention provides a computer product, method, and system for managing patient prescription information. A patient prescription for a specified medication is received, typically at a pharmacy, where the availability of insurance coverage from an insurance company for the patient prescription is verified. In addition, an insurance payment category for the prescription is verified. Payment is collected from the patient based on the payment category. The payment category and the payment is transmitted to the insurance company exclusive of the medication information.

Upon collection of the proper payment amount, the prescription is dispensed to the patient. The payment category preferably is selected from brand name, generic, and not covered, such that information regarding the specific medication prescribed is not transmitted to the insurance company. For purposes of patient safety, a patient's preexisting prescription information and patient insurance information preferably is collected from a storage medium, such as a smart card or a local database at a pharmacy. A pharmacist preferably is allowed by the patient to check for adverse reactions between the patient prescription and at least one preexisting patient prescription.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system client in which the present invention may be implemented;

FIG. 4 is a schematic representation of a smart card in accordance with one embodiment of the present invention; and

FIG. 5 is a flow diagram of an exemplary process in accordance with one embodiment of the present invention.

### DETAILED DESCRIPTION OF THE INVENTION

The present invention relates to a system and method for storing and managing patient prescription information. Generally, prescription information is stored in a secure fashion and disseminated to the insurance carrier in a fashion sufficient to authorize payment but not inform the insurance company which particular drug is prescribed. The system and method may be carried out by storing the patient information on a smart card or other memory storage medium and reading the information at the pharmacy. The description of the preferred embodiments herein are not intended to be limiting. One of ordinary skill in the art could implement the invention in a variety of ways.

In one embodiment of the present invention, patient prescription information is stored on a secure data storage medium. The prescription information may include current as well as past prescriptions for the patient. The storage medium may also include prescription information for family members. The storage medium may also store information regarding the patient's insurance coverage. Patient prescription information is maintained confidential and upon authorization by the patient, the information may be released to a pharmacy or other third party. It is preferred that a pharmacy dispensing medication to a patient have access to all medications prescribed to the patient in order to detect potential adverse reactions between medications.

The prescription information may be maintained on a data storage medium at a pharmacy, on a central server maintained by a third party, on a portable storage medium such as a smart card or a combination thereof.

Third party access to the prescription information may be granted by the patient on an individual basis. For example, if an insurance company requests further information regarding a claim the patient may grant access to the patient's prescription history related to the claim. Queries may be created that target medications prescribed for a specific condition during a given time period. The majority of patient prescription information is recorded in the patient's medical information maintained by the patient's physician(s). This prescription information is ultimately available to the patient's insurer as well thus, the need for insurance company access to the prescription information maintained in the data storage medium information is diminished.

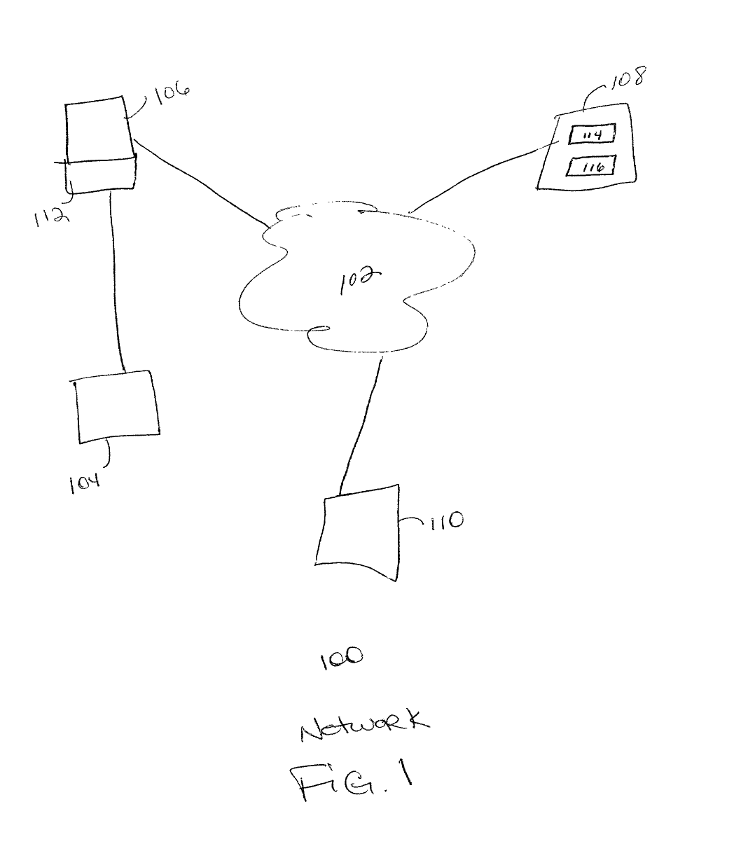

FIG. 1 shows network 100 for controlling access to information stored on a smart card 104. In the embodiment shown, the information includes prescription information. Network 100 includes a computer 106 located at a pharmacy and computers 108 and 110 located at insurance companies. The computers are interconnected via network connection 102, such as the Internet. Pharmacy terminals 106 comprises a smart card reader 112 for reading information from, and writing information to, the smartcards of individual patients seeking prescription services. A patent's smartcard typically includes medical information and insurance information together with encryption keys, certificates and other data needed to control access to the medical information. The insurance company computer 108 and 110, are preferably enabled to send and receive information to and from the pharmacy computer 106. Computer 108 preferably contains a patient database 114 that contains coverage information for insured patients including co-pay amounts, pharmacy limits and any other coverage information. Computer 108 also preferably has a medication database 116 containing information regarding brand name and generic medications as well as medications that are not covered by the insurer. While only one pharmacy computer 106 and two insurance computers 108 and 110 are shown, primarily for ease of description, it will be apparent to those skilled in the art that multiple pharmacy computers and multiple insurance computers may be connected via network 102. Network 102 can be any type of communication network such as the Internet.

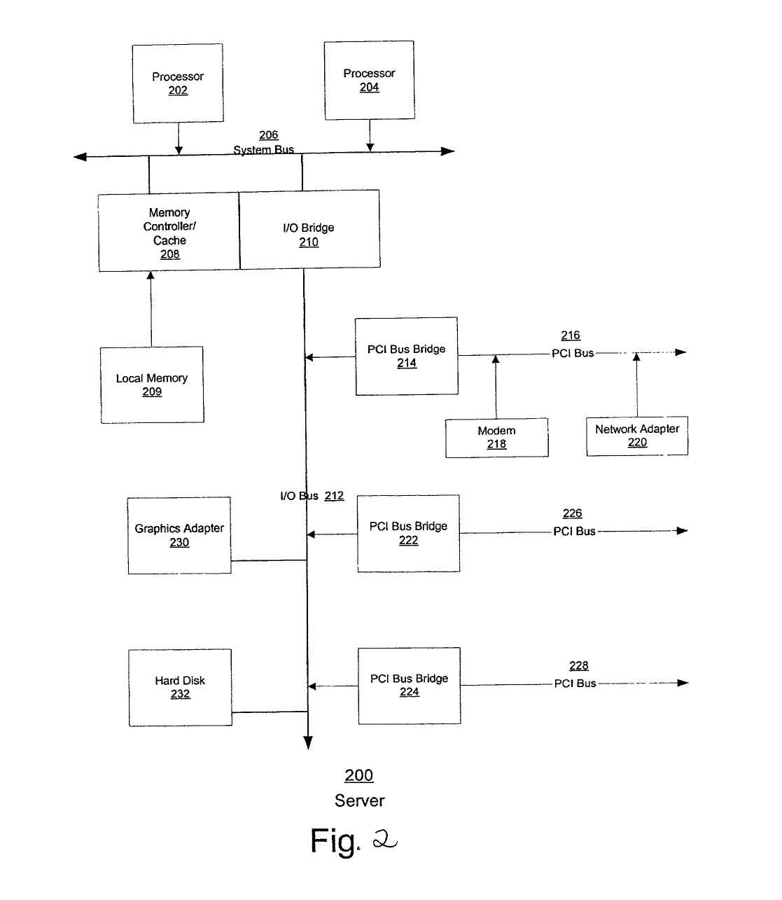

Referring to FIG. 2, a block diagram of a data processing system that may be implemented as a server computer, such as insurance company computer 108, 110 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209 where insurance coverage information and medication information may be stored for access by a pharmacy. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention. Standard components such as a keyboard, mouse and display are not shown in this figure.

The data processing system depicted in FIG. 2 may be, for example, an eServer pSeries system, a product of International Business Machines Corporation in Armonk, N.Y., running the Advanced Interactive Executive (AIX) or Linux operating systems.

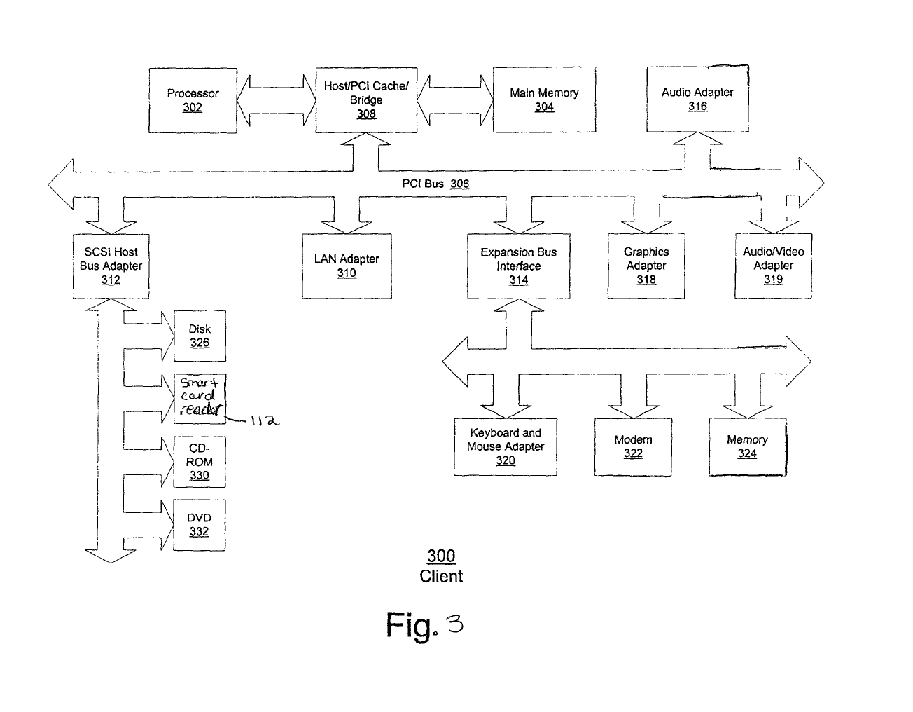

With reference now to FIG. 3, a block diagram illustrating a data processing system is depicted in which the present invention may be implemented. Data processing system 300 is an example of a client computer such as computer 106 shown in FIG. 1. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, SCSI host bus adapter 312, and expansion bus interface 314 are connected to PCI local bus 306 by direct component connection. In contrast, local area network (LAN) adapter 310, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, smart card reader 112, CD-ROM drive 330, and DVD drive 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

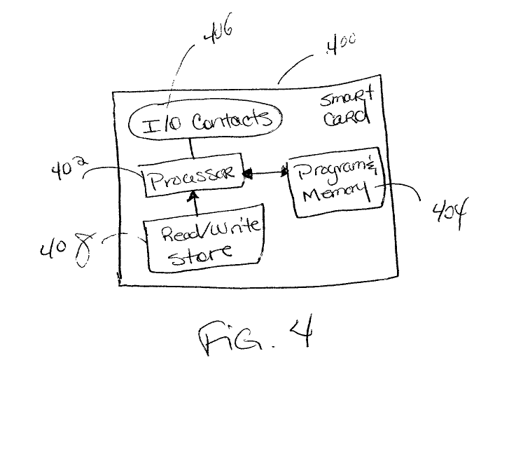

FIG. 4 is a schematic block diagram of a smartcard suitable for use with one embodiment of the subject invention. In FIG. 4 smartcard 400 includes a conventional microprocessor 402 which communicates with conventional program and working memory 404, and includes I/O contacts 406 for communication between microprocessor 402 and card reader 112, shown in FIG. 1. Smartcard 400 also includes an optical read/write store 408. Since there is no direct communication between store 404 and microprocessor 402 data is transferred between store 404 and microprocessor 402 through card reader 112. Accordingly, security of data in store 404 relies upon encryption of the data by microprocessor 404, as will be described further below. Smartcards substantially similar to smartcard 400, as well as compatible readers, are commercially available from Lasercard Systems Corporation, Mountain View Calif. (a subsidiary of Drexler Technology Corporation), and are described in an electrically published document LASERCARD SYSTEMS Technical Information http://www.lasercard.com/lsctec0.html, and need not be discussed further here for an understanding of the subject invention.

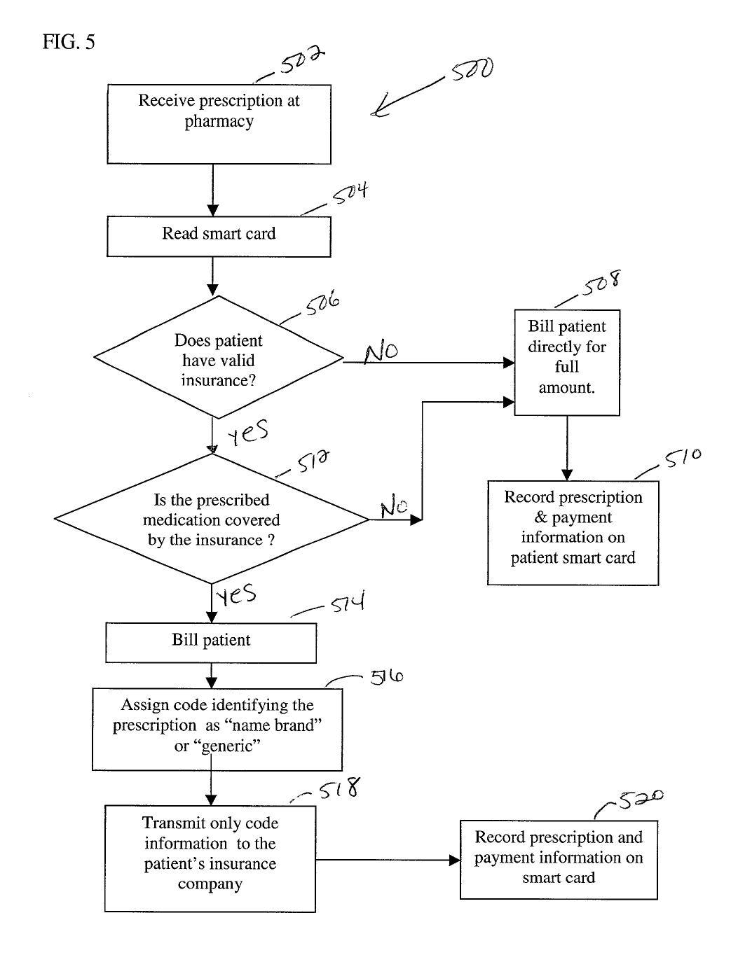

FIG. 5 is a flow diagram of an exemplary process 500 in accordance with the present invention. Typically, a doctor prepares a prescription for a patient. The patient takes the prescription to a pharmacy to be filled, step 502. The pharmacy personnel read the patient's smart card to obtain insurance and prescription information, step 504. The pharmacy may also choose to make a local copy of the patient information stored on the card, if authorized by the patient. The pharmacy queries the insurer's server for information regarding the patient, particularly, does the patient have valid insurance, step 506. If the patient does not have valid insurance, then the patient is billed directly for the full amount of the prescription, step 508. The prescription and optionally the payment information is recorded on the patient's smart card for future reference, step 510. If the patient does have insurance, then the insurance database is queried to determine if the medication prescribed is covered, step 512. If the medication is covered, the patient is billed accordingly, step 514. The pharmacy assigns an identifier code to the prescription, such as 001 for brand name and 002 for generic, step 516. The pharmacy transmits the prescription code along with the amount paid by the patient to the insurance company, step 518. The pharmacy then records the payment and prescription information on the patient's smart card, step 520. It is important to note that if the patient does not have insurance, or if the medication is not covered by the current policy, once the patient is billed, the process ends and no prescription and/or payment information is transmitted to the insurer.

The patient may obtain a smart card from an independent vendor or from his or her insurance company. Any general insurance policies such as co-pay for generic medications, co-pay for name brand medications, period of insurance, and any other policies such maximum prescription coverage per family may be maintained on the card. This information is also maintained in the insurer's database. The insurance company database may be accessed from a pharmacy to retrieve and update insurance coverage information when a patient presents a prescription to be filled. Preferably, the insurance company server has a database containing generic and name brand classifications for covered medications and a list of medications that are not covered by the insurance policy.

There will be instances where it is necessary to divulge patient prescription information to the patient's insurer. Under these circumstances, the patient may authorize disclosure of some or all of the information resident on his/her smart card. The information may be read at a pharmacy or other facility with a means for reading the card and transmit the information to the insurer.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

We claim:

1. A method comprising:
receiving a patient prescription for a specified medication;
verifying availability of insurance coverage from an insurance company for the patient prescription;
verifying an insurance payment category for the prescription;
collecting a payment from the patient based on the payment category; and
transmitting the payment category and the payment to the insurance company excluding the medication information.

2. The method of claim 1 wherein the payment category is selected from brand name, generic, and not covered.

3. The method of claim 1 further comprising dispensing the prescription to the patient.

4. The method of claim 1 further comprising collecting patient preexisting prescription information and patient insurance information from a storage medium.

5. The method of claim 4 further comprising recording the prescription and the payment on the storage medium.

6. The method of claim 1 further comprising checking for adverse reactions between the patient prescription and at least one preexisting patient prescription.

7. A method comprising:
storing patient prescription information on a storage medium;
providing unlimited access to the prescription information to the patient; and
providing limited access to the prescription information to third parties in response to authorization by the patient.

8. A computer program product in a computer readable medium for use in a data processing system, for managing patient prescription information the computer program product comprising:
instructions for receiving a patient prescription for a specified medication;
instructions for verifying availability of insurance coverage from an insurance company for the patient prescription;
instructions for verifying an insurance payment category for the prescription;
instructions for collecting a payment from the patient based on the payment category; and
instructions for transmitting the payment category and the payment to the insurance company exclusive of the medication information.

9. The product of claim 8 wherein the payment category is selected from brand name, generic, and not covered.

10. The product of claim 8 further comprising instructions for dispensing the prescription to the patient.

11. The product of claim 8 further comprising instructions for collecting patient preexisting prescription information and patient insurance information from a storage medium.

12. The product of claim 11 further comprising instructions for recording the prescription and the payment on the storage medium.

13. The product of claim 8 further comprising instructions for checking for adverse reactions between the patient prescription and at least one preexisting patient prescription.

14. System for managing patient prescription information system comprising:
receiving means for receiving a patient prescription for a specified medication;
first verifying means for verifying availability of insurance coverage from an insurance company for the patient prescription;
second verifying means for verifying an insurance payment category for the prescription;
collecting means for collecting a payment from the patient based on the payment category; and
transmitting means for transmitting the payment category and the payment to the insurance company exclusive of the medication information.

15. The system of claim 14 wherein the payment category is selected from brand name, generic, and not covered.

16. The system of claim 14 further comprising dispensing means for dispensing the prescription to the patient.

17. The system of claim 14 further comprising collecting means for collecting patient preexisting prescription information and patient insurance information from a storage medium.

18. The system of claim further comprising recording means for recording the prescription and the payment on the storage medium.

19. The product of claim 18 further comprising checking means for checking for adverse reactions between the patient prescription and at least one preexisting patient prescription.
